(19) United States
(12) Patent Application Publication
(10) Pub. No.: US 2013/0098789 A1
(43) Pub. Date: Apr. 25, 2013

(54) DEVICE STORAGE PACKAGE

(71) Applicant: Pantech Co., Ltd., Seoul (KR)

(72) Inventors: Sae Woong JUN, Seoul (KR); Bo Young KANG, Seoul (KR); Song Yi LEE, Seoul (KR)

(73) Assignee: PANTECH CO., LTD., Seoul (KR)

(21) Appl. No.: 13/658,203

(22) Filed: Oct. 23, 2012

(30) Foreign Application Priority Data
Oct. 24, 2011 (KR) 10-2011-0108917

(51) Int. Cl. B65D 85/00; G06F 1/18

(52) U.S. Cl. 206/320

(57) ABSTRACT

A device storage package includes a mounting part to hold a mobile device, a support part connected to the mounting part and bent to form a reference angle with respect to the mounting part, and a support piece to connect the mounting part and the support part.

### CROSS-REFERENCE TO RELATED APPLICATION

This application claims priority from and the benefit of Korean Patent Application No. 10-2011-0108917 filed on Oct. 24, 2011, the contents of which are incorporated herein by reference in their entirety.

### BACKGROUND

1. Field

Exemplary embodiments of the present invention relate to a device storage package.

2. Discussion of the Background

As a variety of communication devices have emerged, the number of users of the communication devices may be increasing. The communication devices may be packed into individual packages for marketing, which may be thrown away without being used after opening. When the packages are thrown away, however, disposal costs may be incurred by society.

### SUMMARY

Exemplary embodiments of the present invention provide a device storage package.

Additional features of the invention will be set forth in the description which follows, and in part will be apparent from the description, or may be learned by practice of the invention.

Exemplary embodiments of the present invention provide a device storage package including a mounting part to hold a mobile terminal; a support part connected to the mounting part and bent to form a reference angle with respect to the mounting part; and a support piece to connect the mounting part and the support part.

Exemplary embodiments of the present invention provide a device storage package including a first part to form an outer shell; and a second part to form an insert to mount a mobile terminal in the second part, in which both the first part and the second part is bendable along a bending region to form a support structure comprising a mounting part and a support part.

Exemplary embodiments of the present invention provide a device storage package including a first region; a second region connected to the first region at a first bending region; and a third region connected to the second region at a second bending region, in which an edge of the first region contacts the first bending region and the second bending region at a same location.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a device storage package according to an exemplary embodiment of the present invention.

FIG. 2 illustrates an opened state of the device storage package shown in FIG. 1.

FIG. 3 is a perspective view of a device storage package according to an exemplary embodiment of the present invention.

FIG. 4 is a development view of a first part of a device storage package according to an exemplary embodiment of the present invention.

FIG. 5 is a perspective view of the first part shown in FIG. 4.

FIG. 6 is a development view of a second part of a device storage package according to an exemplary embodiment of the present invention.

FIG. 7 is a perspective view of the second part shown in FIG. 6.

FIG. 8 is a perspective view illustrating a state in which a first part is inserted into a second part in the device storage package according to an exemplary embodiment of the present invention.

FIG. 9 is a perspective view illustrating a bent state of the device storage package of FIG. 8.

FIG. 10 is a side view of the device storage package of FIG. 9.

FIG. 11 is a development view of a first part in a device storage package according to an exemplary embodiment of the present invention.

FIG. 12 is a development view of a second part in a device storage package according to an exemplary embodiment of the present invention.

FIG. 13 is a perspective view illustrating a state of a device storage package in which the first part is inserted into the second part according to an exemplary embodiment of the present invention.

FIG. 14 is a side view of the device storage package of FIG. 13.

FIG. 15 is a development view of a device storage package according to an exemplary embodiment of the present invention.

FIG. 16 is a perspective view illustrating a process of rolling and coupling the device storage package of FIG. 15.

FIG. 17 is a perspective view of the completed device storage package of FIG. 16.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Hereinafter, various configurations of a device storage package according to exemplary embodiments of the present invention will be described.

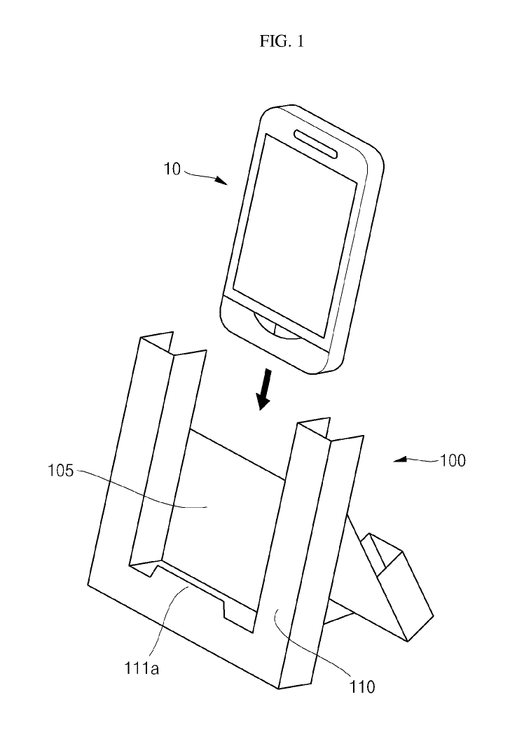

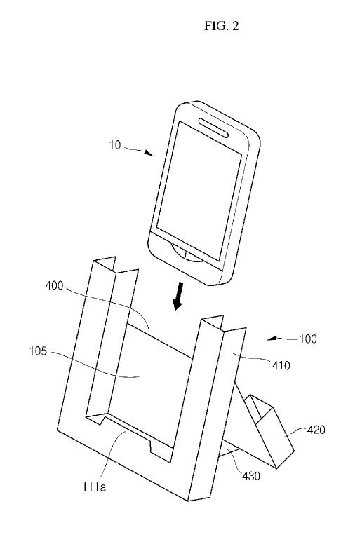

FIG. 1 is a perspective view of a device storage package according to an exemplary embodiment of the present invention. FIG. 2 illustrates an opened state of the device storage package shown in FIG. 1.

Referring to FIG. 1 and FIG. 2, the device storage package 100 may be configured to be used as a stand or a package to mount or store a device 10.

The device storage package 100 includes a mounting groove 105, which may be recessed to form a cavity and to allow the device 10 to be mounted therein. The mounting groove 105 may be sized and shaped to allow the device 10 to be mounted. The mounting groove 105 may be shaped to be similar to external edges of the device 10 and may have a size larger than or equal to a size of the device 10. However, aspects of the invention are not limited thereto, such that the mounting groove 105 may be sized and shaped to allow mounting of the device 10 in various orientations or to allow mounting of a different device. In an example, the device 10 may include, without limitation, a mobile terminal, a personal digital assistant (PDA), a tablet computer, a mobile audio device, and the like.

In addition, in order to reduce the likelihood of the mounted device 10 from falling out of place from the mounted position, a locking projection 111a may be inwardly protruded with respect to the mounting groove 105. Further, the locking projection 111a may be provided in at least one of the edges of the mounting groove 105. In an example, the locking projection 111a may be disposed at the bottom portion of the mounting groove 105 and protrude in an up direction toward the inside of the mounting groove 105. However, aspects are not limited thereto, such that one or more locking projections 111a may be disposed at the side portions of the mounting groove 105.

In addition, the device storage package 100 may have a bendable region, which may be bent or folded in one or more directions to form a supporting part that may support or hold the device 10. More specifically, one or more bending regions 400 and cutting or dividing regions may be formed at portions of the device storage package 100. Further, the bending regions may be formed horizontally in a left direction and a right direction of the device storage package 100. However, aspects are not limited thereto, such that the bending regions may be formed vertically, diagonally, or in a pattern. The cutting regions or dividing regions may be formed on one or more portions of the device storage package 100 to allow one or more portions to be movable or bendable with respect to the remaining portions of the device storage package 100.

Further, one or more portions of the device storage package 100 may become bent and folded in a direction with respect to the bending regions, so that a first portion of the device storage package 100 or a mounting part 410, and a second portion of the device storage package 100 or a supporting part 420 may mount or hold the device 10 in the device storage package 100. The supporting part 420 may be bent at a reference angle with respect to the mounting part 410 to form an ‘A’ shape. Further, the device storage package 100 may include a support piece 430 to connect bottom portions of the mounting part 410 and the supporting part 420 to provide additional stability to the device storage package 100.

As shown in FIG. 1 and FIG. 2, the bending regions may be formed at portions inside the mounting groove 105. A top portion of the device storage package 100 with respect to the bending region may be bent and folded in a rearward direction to form the supporting part 420. A bottom portion of the device storage package 100 with respect to the bending region may form the mounting part 410. The mounting groove 105 of the mounting part 410 may have a left side surface, a right side surface and a bottom surface with an open top surface, to allow storage of the device 10. In addition, as shown in FIG. 1 and FIG. 2, while the mounting part 410 may be formed at a reference angle towards a rearward direction, the locking projection 111a is formed at the bottom end of the mounting groove 105 to secure the device 10. However, aspects are not limited thereto, such that one or more locking projections 111a may be formed at the side portions of the mounting groove 105. Further, although not illustrated, the mounting part 410 and the support part 420 may be similarly shaped, such that the respective portions may be used interchangeably.

The device storage package 100 may be integrally formed using various materials and include a plurality of component pieces that may be capable of being assembled or disassembled. The respective component pieces may be formed by bending or cutting some of plate-shaped components that may be made of at least one of paper, synthetic resin, plastic, rubber, or the like. The following description will focus more on exemplary embodiments in which the device storage package 100 may include two or more component pieces.

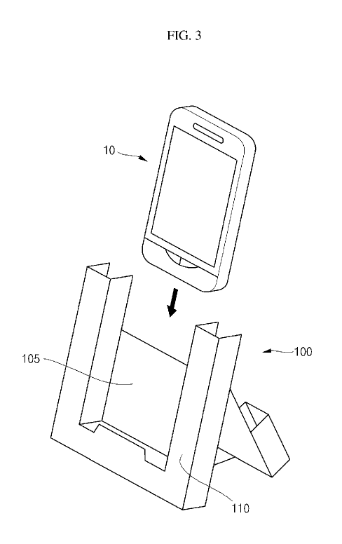

FIG. 3 is a perspective view of a device storage package according to an exemplary embodiment of the present invention.

Referring to FIG. 3, the device storage package 100 includes a first part 110, which may form an external shape of the device storage package 100, and a second part 120, which may be positioned inside of the first part 110.

The device storage package 100, including the first part 110 and the second part 120, may be provided as a part of packaging material that may be used to package the device 10 to be distributed as a product. The device storage package 100 may be separately procured or purchased to be used as an accessory to the device 10. Further, the device storage package 100 may form a shell having a mounting groove formed therein to protect or secure the device 10 within the device storage package 100.

The device storage package 100 may operate as a storage unit independently of a product package after the device storage package is separated from rest of the product packaging. A portion of the first part 110 of the device storage package 100 may be cut and bent in a rearward direction to form a triangular shaped support structure as shown in FIG. 2. More specifically, the a portion of the first part 110 may be cut along a cutting region, which may allow an upper portion or a first portion of the first part 110 to be bendable with respect to a lower portion or a second portion of the first part 110. In addition, the device 10 may be inserted into the device storage package 100 using the mounting groove formed according to the first part 110 and the second part 120 to be mounted. Thus, the device 10 can be mounted or stored within the device storage package 100. However, aspects of the invention need not limited to a triangular shaped support structure, such that the first part 110 may be folded or bent multiple times to form a trapezoid or other geometrical shaped support structure.

Hereinafter, configurations of the device storage package according to exemplary embodiments of the present invention will be described in more detail.

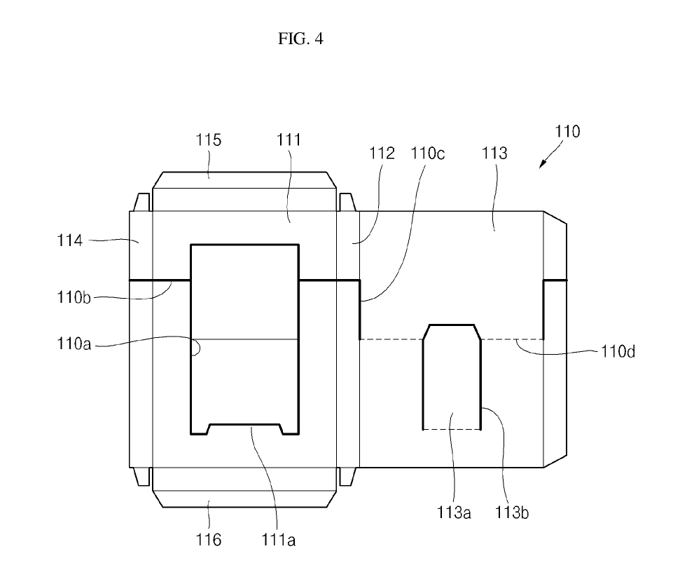

FIG. 4 is a development view of a first part of a device storage package according to an exemplary embodiment of the present invention.

Referring to FIG. 4, in the device storage package 100, the first part 110 may include a first region 111, a second region 112 connected to a first side or a right side of the first region 111, a third region 113 connected to the second region 112, a fourth region 114 connected or connectable to a second side or a left side of the first region 111, a fifth region 115 formed at an upper side of the first region 111, and a sixth region 116 formed at a lower side of the first region 111.

The first region 111 includes a centrally formed mounting hole 110a. The mounting hole 110a may provide a region to mount the device 10 in an assembled structure. The mounting hole 110a of the first region 111 may include a cutting region or a cutting hole 110b, which may be formed by cutting a portion of the second region 112 and the fourth region 114 from opposite surfaces of the mounting hole 110a. The first region 111, the second region 112 and the upper side of the fourth region 114 may be separated from each other through the cutting hole 110b, and the separated portions may be bent rearward along a bendable region or a bending line 110d.

The second region 112 is formed at the first side of the first region 111 to have similar or the same length with the first region 111 in a direction perpendicular to the first region 111. The second region 111 may be bent rearward by approximately 90 degrees to form a thickness of the first region 111. In addition, the cutting hole 110b may intersect the second region 112 and may further include a cutting region or a cutting hole 110c, which may be formed at a predetermined location along the boundary between the second region 112 and the third region 113. More specifically, the a portion of the first part 110 may be cut along the cutting regions (i.e., cutting hole 110b and cutting hole 110c), which may allow an upper portion or a first portion of the first part 110 to be bendable with respect to a lower portion or a second portion of the first part 110.

The third region 113 is connected to the second region 112. Further, the third region 113 may be bent at the boundary between the second region 112 and the third region 113 by approximately 90 degrees, so that the third region 113 may be formed to be substantially parallel with the first surface 111. In addition, a portion of the third region 113 is connected to the fourth region 114 to form a rectangular pillar. However, aspects are not limited thereto, such that the third region may be connected to fourth region to form a triangularly shaped pillar, a round pillar, or a pillar with other geometric shapes. In addition, the third region 113 may be bent again rearward at a portion in contact with the cutting hole 110c through the bending line 110d, which intersects the third region 113. In addition, the third region 113 may include a support region 113a formed therein. The support region 113a may extend to a bent region and connect thereto to support the overall structure of the device storage package 110. However, aspects are not limited thereto, such that the support region 113a may provide additional support to prop a support portion of the first part 110 without connecting to a mounting portion of the first part 110.

The fourth region 114 may be formed at the second side or the right side of the first region 111. The cutting hole 110b may be formed to intersect the fourth region 114. In addition, the fourth region 114 may be bent rearward to form approximately 90 degrees with the first region 111. In addition, a portion of the third region 113 may be connected to the inside of the fourth region 114 to form a rectangular shape.

The fifth region 115 is formed at the upper side of the first region 111. The fifth region 115 may be bent twice rearward and bent portions of the fifth region 115 may be parallel with the first region 111. In addition, the bent portions of the fifth region 115 may be connected to the third region 113 to contact the third region 113.

The sixth region 116 is formed at the lower side of the first region 111. The sixth region 116 may be bent twice rearward and bent portions of the sixth region 116 may be connected to the third region 113 to contact the sixth region 116.

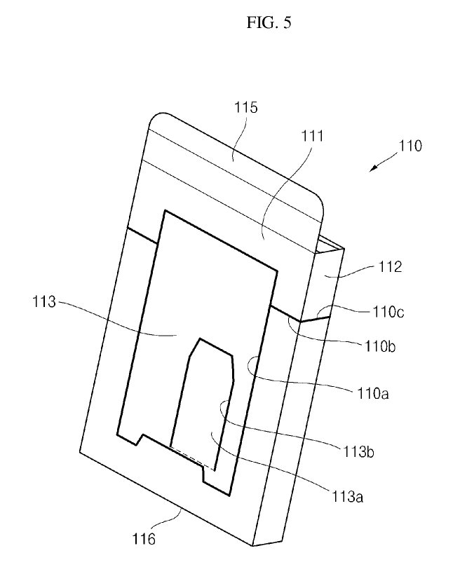

FIG. 5 is an assembled view of the first part shown in FIG. 4.

In the first part 110, if the second region 112 and the fourth region 114 are bent rearward by approximately 90 degrees and the third region 113 is bent again from the second region 112 by approximately 90 degrees, a partially assembled device storage package may be formed as shown in FIG. 5. In addition, a portion of the third region 113 may be connected to the fourth region 114 to provide an assembled left side of the device storage package.

In addition, the fifth region 115 and the sixth region 116 may be bent twice, respectively, to form an assembled upper side and lower side of the device storage package. Further, the respective bent portions of the fifth region 115 and the sixth region 116 may contact or be connected to the third region 113 and the first region 111, which may be oriented in parallel with each other. Therefore, the first part 110 may have a shape of a substantially rectangular pillar. However, aspects of the invention are not limited to rectangular shaped pillars, and may include other geometrical shaped figures.

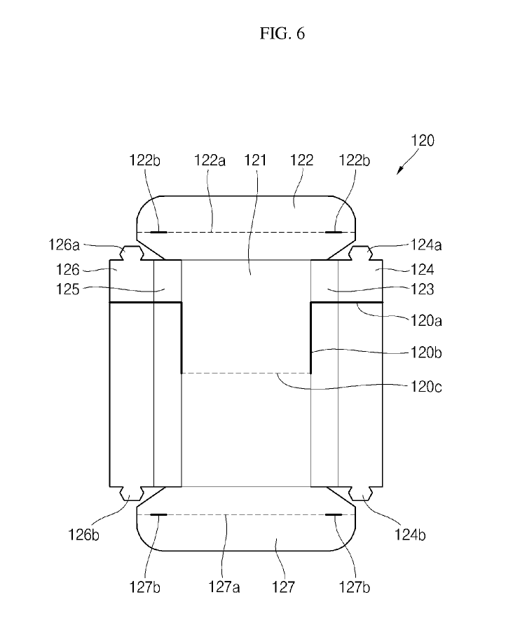

FIG. 6 is a development view of a second part in a device storage package according to an exemplary embodiment of the present invention.

Referring to FIG. 6, the second part 120 includes a first region 121, a second region 122 formed at an upper side of the first region 121, a third region 123 formed at a first side or a right side of the first region 121, a fourth region 124 connected to the third region 123, a fifth region 125 formed at a second side or a left side of the first region 121, a sixth region 126 connected to the fifth region 125, and a seventh region 127 formed at a lower side of the first region 121.

While the first region 121 is shaped of a rectangle, the second region 122 is formed at an upper side of the first region 121. The second region 122 may be bent with respect to the first region 121 by approximately 90 degrees to be oriented perpendicular to the first region 121. In addition, the second region 122 includes a bending line 122a formed therein, so that a portion of the second region 122 may be bent along the bending line 122a by approximately 90 degrees. Therefore, the end portion of the second region 122 may bent to be in parallel with the first region 121. In addition, an insertion hole 122b may be formed at end portions of the bending line 122a, and portions of the fourth region 124 and the sixth region 126 may be inserted into the insertion holes 122b to connect the second region 122 to the fourth region 124 and the sixth region 126.

The third region 123 is formed at the right side of the first region 121. The third region 123 is formed in a lengthwise direction of the first region 121. The third region 123 may be bent forward from the first region 121 by approximately 90 degrees. More specifically, the third region 123 may be bent to be oriented perpendicularly to the first region 121. The third region 123 has a cutting region or a cutting hole 120a formed therein to intersect the third region 123. In addition, the third region 123 may include a cutting region or a cutting hole 120b, which may be formed at a portion of the first region 121 and the portion contacting the cutting hole 120a. More specifically, the cutting region of the first region 121 may refer to a region in which the second part 120 may be partially cut so that an upper portion of the second part 120 may be bendable along a bending region 120c. Therefore, after the third region 123 is bent with respect to the first region 121, upper regions may be independently bent rearward with respect to the first region 121 through the cutting hole 120a and the cutting hole 120b.

The fourth region 124 is connected to the third region 123. The fourth region 124 may be bent at a boundary with respect to the third region 123 by approximately 90 degrees from the third region 123. Therefore, the fourth region 124 may become substantially parallel with the first region 121 when the fourth region 124 is bent. In addition, the fourth region 124 includes an insertion part 124a and an insertion part 124b protruding upwardly and downwardly, respectively. The insertion part 124a and the insertion part 124b may engage with an insertion hole 122b of the second region 122 and an insertion hole 127b of the seventh region 127, to maintain a state in which the fourth region 124 is engaged with the second region 122. In addition, the fourth region 124 may have a cutting hole 120a formed therein to intersect the inside of the fourth region 124, and to allow the fourth region 124 to be bent rearward with respect to the first region 121.

The fifth region 125 is formed at the left side or the second side of the first region 121. The fifth region 125 includes a cutting hole 120a and a cutting hole 120b to be parallel with the cutting hole 120a and the cutting hole 120b of the third region 123. The fifth region 125 may be later bent forward with respect to the first region 121 by approximately 90 degrees or a different reference angle from the first region 121, like the third region 123.

The sixth region 126 is connected to the fifth region 125. The sixth region 126 may be bent along a boundary or an edge of the fifth region 125 by approximately 90 degrees to form the sixth region 126 to be parallel with the first region 121. Since the sixth region 126 includes an insertion part 126a and an insertion part 126b formed at upper and lower sides thereof, the insertion part 126a and the insertion part 126b may be inserted into the insertion hole 122b of the second region 122 and the insertion hole 127b of the seventh region 127.

The seventh region 127 is formed at the lower side of the first region 121. The seventh region 127 is formed to be parallel with the second region 122. The seventh region 127 may be bent once to be perpendicular to the first region 121 and may be bent again along a bending line 127a so that a portion of the seventh region 127 is parallel with the first region 121. In addition, the insertion part 124b of the fourth region 124 and the insertion part 126b of the sixth region 126 may be engaged with the insertion hole 127b formed at a portion of the bending line 127a.

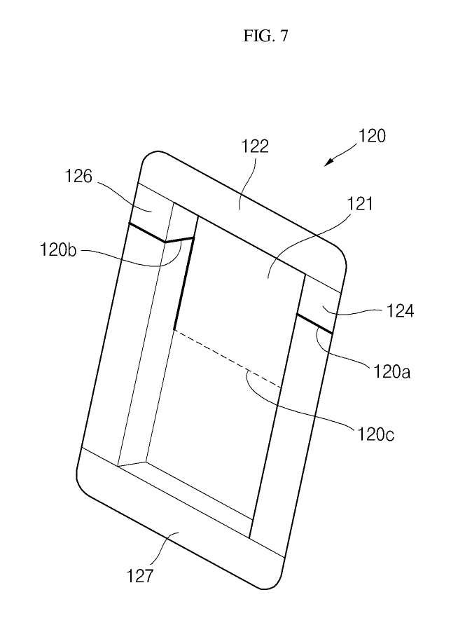

FIG. 7 is a perspective view of the second part shown in FIG. 6.

Referring to FIG. 7, the second part 120 is bent forward with respect to the first region 121 such that the second region 122 and the seventh region 127 form a reference angle. In an example, the reference angle may be approximately 90 degrees. In addition, portions of the second region 122 and the seventh region 127 are bent again by approximately 90 degrees. The fourth region 124 and the sixth region 126 are bent forward from sides of the first region 121 by approximately 90 degrees. In addition, the fourth region 124 and the sixth region 126 are bent along edges of the third region 123 and the fifth region 125, respectively to allow the fourth region 124 and the sixth region 126 to be oriented in parallel with the first region 121. In addition, the insertion part 124a and the insertion part 124b of the fourth region 124 and the insertion part 126a and the insertion part 126b of the sixth region 126 may be engaged with the insertion hole 122b of the second region 122 and the insertion hole 127b of the seventh region 127, respectively. Further, the second part 120 may be inserted into the first part 110. The second part 120 may be cut along the cutting hole 120a and the cutting hole 120b, and along a portion of the edges of the third region 123 and the fifth region 125. Accordingly, the second part 120, which may have separated portions that may be bent rearward along the bending line 120c.

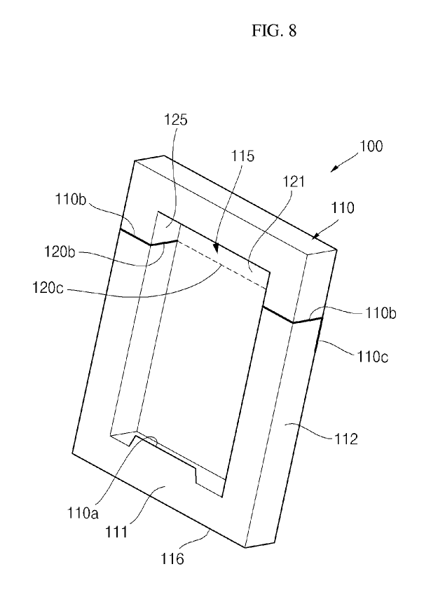

FIG. 8 is a perspective view illustrating a state in which the first part is inserted into a second part in the device storage package according to an exemplary embodiment of the present invention.

Referring to FIG. 8, the second part 120 may be inserted into the inside of the first part 110. Here, the cutting hole 110b and the cutting hole 110c of the first part 110 may be engaged with the cutting hole 120a and the cutting hole 120b of the second part 120 at corresponding positions. In addition, the bending line 110d of the first part 110 and the bending line 120c of the second part 120 are engaged with each other at a corresponding position. However, aspects of the invention need not be limited thereto, such that a device storage package may be assembled by a single component, or more than two components. Further, a device storage package may be assembled by a separate mounting part and a separate support part, which may be joined together to form a support structure.

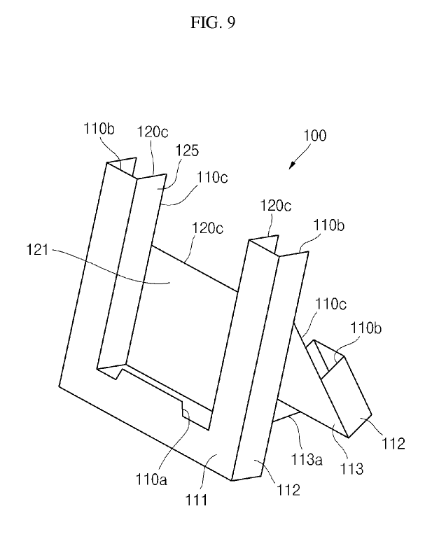

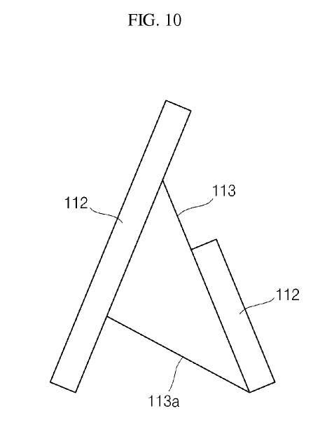

FIG. 9 is a perspective view illustrating a bent state of the device storage package of FIG. 8. FIG. 10 is a side view of the device storage package of FIG. 9.

Referring to FIG. 9 and FIG. 10, in a state in which the first part 110 and the second part 120 are engaged with each other, upper sides of the first part 110 and the second part 120 are separated from each other with respect to the cutting hole 110b, the cutting hole 110c, the cutting hole 120a, and the cutting hole 120b. Further, the separated upper sides are bent rearward along the bending line 110d and the bending line 120c. Here, the support region 113a of the first part 110 is bent from the third region 113 to be inserted into a gap, which may be formed where the third region 113 and the fifth region 115 are engaged with each other. The support region 113a may connect a support part and a mounting part to support a bent structure including the first part 110 and the second part 120.

Therefore, the device 10 may be inserted from the top or the front through the mounting hole 110a of the first part 110 to be mounted in the second part 120. A rear side of the device 10 can be supported by the first region 121 of the second part 120 to maintain the device 10 at a mounted state.

In addition, in a state in which the first part 110 and the second part 120 are cut and bent rearward along the bending line 110d of the first part 110 and the bending line 120c of the second part 120, simple items, such as pencils, ballpoint pens, or the like can be accommodated in a space formed in the side pillars along the cutting hole 110b and the cutting hole 120b.

As described above, the device storage package 100 according to exemplary embodiments of the present invention may modify a package shell to store the device 10, and form an accommodation space by bending to accommodate simple items.

Hereinafter, a configuration of a device storage package according to exemplary embodiments of the present invention will be described.

Since the device storage package 200 according to exemplary embodiments of the present invention may be similar to the aforementioned device storage package 100, the following description will focus on some of the differences between the device storage package 100 and the device storage package 200.

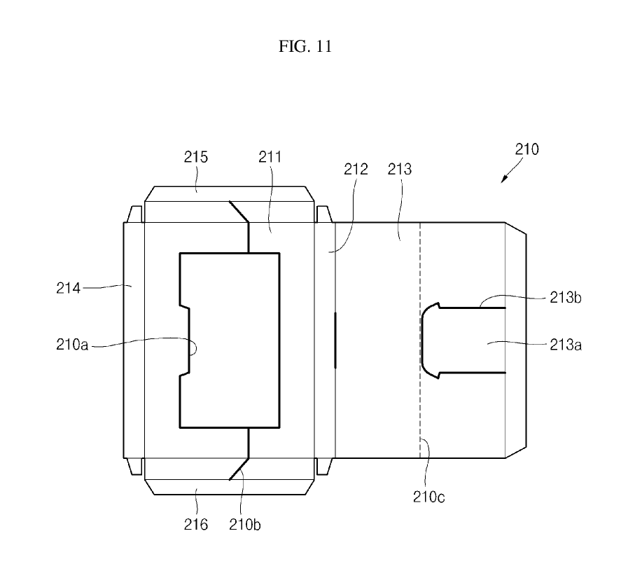

FIG. 11 is a development view of a first part in a device storage package according to an exemplary embodiment of the present invention.

Referring to FIG. 11, in the device storage package 200, a first part 210 includes a first region 211, a second region 212, a third region 213, a fourth region 214, a fifth region 215 and a sixth region 216. On the development view shown in FIG. 11, a positional relationship between the six enumerated regions in the first part 210 may be the same or similar as that in the first part 110 of the device storage package 100.

As shown in FIG. 11, the first region 211 includes a mounting hole 210a and a cutting hole 210b extending from opposite sides of the mounting hole 210a. Here, the cutting hole 210a is formed along the lengthwise or parallel direction of the first region 210. Therefore, the first part 210 will later be bent along the lengthwise direction of the first region 211.

A bending line 210c is formed in the lengthwise direction of the third region 213. Further, a portion of the first part 210 may be cut along the cutting hole 210b. The cut portion of the first part 210 may then be bent rearward along the bending line 210c. In addition, the third region 213 includes a support region 213a, which may be engaged or used to support a bent structure of the first part 210.

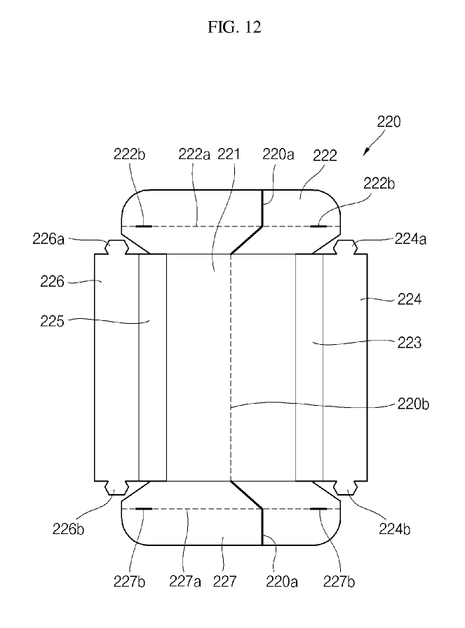

FIG. 12 is a development view of a second part in a device storage package according to an exemplary embodiment of the present invention.

Referring to FIG. 12, the second part 220 includes a first region 221, a second region 222, a third region 223, a fourth region 224, a fifth region 225, a sixth region 226, and a seventh region 227. A connectional relationship between the seven respective regions in the second part 220 may be similar to or the same as that in the second part 120, except for some of the following features.

More specifically, cutting holes 220a are formed in the second region 222 and the seventh region 227, and a bending line 220b is formed along the lengthwise direction of the first region 221. Further, the bending line 220b may is positioned along the same line of the cutting hole 220a. Therefore, the second part 220 may be bent along the lengthwise direction of the first region 211.

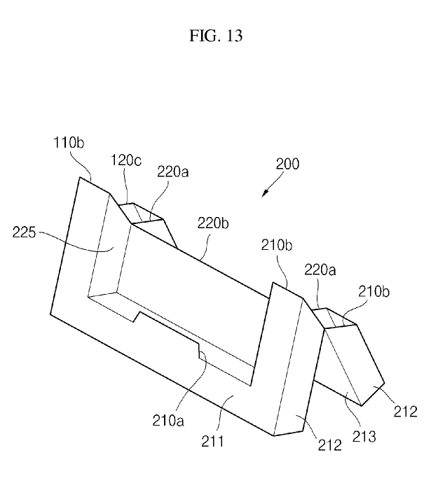

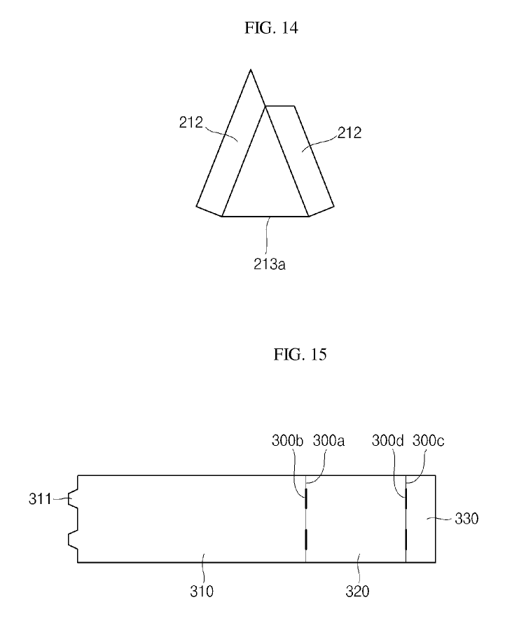

FIG. 13 is a perspective view illustrating a state of a device storage package in which the first part is inserted into the second part according to an exemplary embodiment of the present invention. FIG. 14 is a side view of the device storage package of FIG. 13.

Referring to FIG. 13 and FIG. 14, the second part 220 is inserted into the first part 210, and a portion of the second part 220 and the first part 210 are cut and bent along the bending line 210c, the bending line 220b, and cutting holes 220a. The bending is performed along the lengthwise directions of the first part 210 and the second part 220, and the supporting member 213a of the first part 210 may connect the first part 210 with the second part 220 to support the bent state. However, aspects are not limited thereto, such that the supporting member 213a may provide additional support to prop a bent portion of the device storage package 200 without connecting to a mounting part of the device storage package 200.

Accordingly, the device 10 may be mounted in the device storage package 200 to contact a surface formed in the lengthwise direction of the device storage package 200.

Hereinafter, a configuration of a device storage package according to an exemplary embodiment of the present invention will be described.

FIG. 15 is a development view of a device storage package according to an exemplary embodiment of the present invention.

Referring to FIG. 15, the device storage package 300 according to an exemplary embodiment of the present invention. The device storage package 300 may be formed using a slip to protect a bottom or inner surface of a device package.

The device storage package 300 includes a first region 310, a second region 320 connected to the first region 310, and a third region 330 connected to the second region 320.

The first region 310 may have a substantially rectangular shape. At least one insertion part 311 may be formed at a side of the first region 310. The insertion part 311 protrudes from the one side of the first region 310.

The second region 320 is connected to the first region 310. The second region 320 is connected to the opposite side of the insertion part 311 of the first region 310. The second region 320 has a bending line 300a at a boundary with the first region 310 and includes insertion holes 300b formed at a portion of the bending line 300a. The insertion holes 300b are formed to correspond to the insertion part 311.

The third region 330 is connected to the second region 320. The bending line 300c is provided between the third region 330 and the second region 320. The third region 330 includes insertion holes 300d formed at a portion of the bending line 300c to correspond to the insertion part 311.

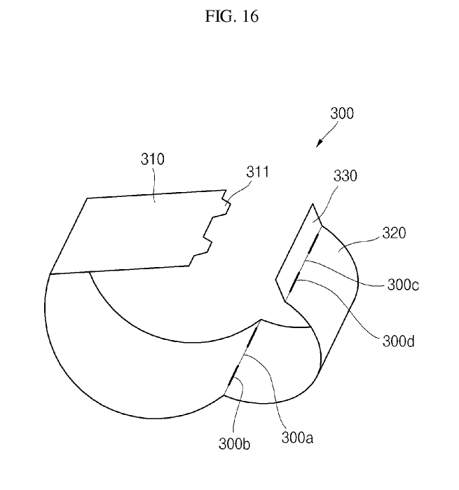

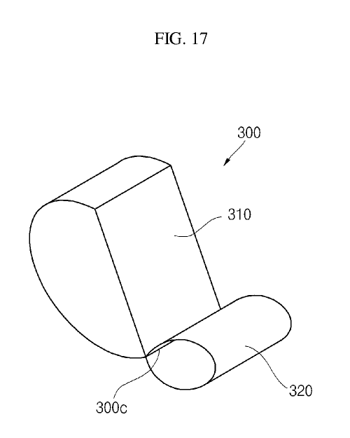

FIG. 16 is a perspective view illustrating a process of rolling and coupling the device storage package of FIG. 15. FIG. 17 is a perspective view of the completed device storage package of FIG. 16.

Referring to FIG. 16 and FIG. 17, the first region 310 and the second region 320 may be rolled to face each other along the bending line 300b positioned between the first region 310 and the second region 320. Further, the first region 310 may include a bending portion and a flat portion, in which the bending portion may be folded or bent along an edge joining the bending portion and the flat portion. In an example, the device 10 may be mounted against the flat portion of the first region. However, aspects of the invention are limited thereto, such that the first region 310 may include a single bending portion.

In addition, in a state in which the bending line 300c, which is located between the second region 320 and the third region 330, is moved or bent to be positioned on the bending line 300a, the insertion part 311 of the first region 310 may vertically penetrate the insertion holes 300d and the insertion holes 300b to be coupled. Therefore, the device storage package 300 according to an exemplary embodiment of the present invention is assembled as shown in FIG. 15. Here, the device 10 may be mounted on the second region 320 to be mounted or stored in the device storage package 300 in contact with the first region 310.

Further, although not illustrated, the device storage package may also include a connector, such as an electrical connector, to connect to the mobile device. However, aspects of the invention are not limited thereto, such that the device storage package may accommodate an external connector to be connected to, inserted into, or mounted on the device storage package to allow a connection with the mobile device. Further, the device storage package may also accommodate Universal Serial Bus (USB) wires and the like as well.

Although bending angles of 90 degrees have been used to describe how various components may be assembled to form a device storage package, the bending angles are not limited thereto. For example, different bending angles may be used to provide differently shaped pillars, body shape, or component parts. Further, a mounting part may be bent at various angles with respect to a supporting part to provide varying support angles for the mounted device.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A device storage package, comprising:
a mounting part to hold a mobile device;
a support part connected to the mounting part, and bendable with respect to the mounting part to form a reference angle; and
a support piece to connect the mounting part and the support part.

2. The device storage package of claim 1, wherein the mounting part comprises a mounting groove.

3. The device storage package of claim 1, wherein the mounting part comprises a locking projection to secure the mobile device.

4. The device storage package of claim 1, wherein at least one of the mounting part, the support part, and the support piece is assembled with a bendable material.

5. The device storage package of claim 1, wherein the support part is capable of holding the mobile terminal.

6. A device storage package, comprising:
a first part to form an outer shell; and
a second part to form an insert to mount a mobile device,
wherein both the first part and the second part are bendable along a bending region to form a support structure comprising a mounting part and a support part.

7. The device storage package of claim 6, wherein the first part comprises a locking projection to secure the mobile device.

8. The device storage package of claim 6, wherein the first part comprises a support piece to connect the mounting part and the support part.

9. The device storage package of claim 6, wherein the first part comprises a cutting region that is cut to allow a first portion of the first part to be bendable with respect to a second portion of the first part.

10. The device storage package of claim 9, wherein the first portion is bent to provide the support part and the second portion provides the mounting part.

11. The device storage package of claim 9, wherein the first portion of the first part is bent along a bending region of the first part.

12. The device storage package of claim 6, wherein the first part comprises a mounting hole in which the mobile device is mountable.

13. The device storage package of claim 6, wherein the second part comprises a cutting region that is cut to allow a first portion of the second part to be bendable with respect to a second portion of the second part.

14. The device storage package of claim 13, wherein the first portion of the second part is bent along a bending region of the second part.

15. The device storage package of claim 6, wherein the second part comprises a mounting portion in which the mobile device is mountable.

16. The device storage package of claim 6, wherein the second part comprises an insertion part.

17. The device storage package of claim 16, wherein the second part comprises an insertion hole through which the insertion part extends.

18. The device storage package of claim 6, wherein the second part is inserted into the second part.

19. The device storage package of claim 6, wherein the second part comprises the bending region.

20. The device storage package of claim 6, further comprising an electrical connector to connect to the mobile device.

21. A device storage package, comprising:
a first region;
a second region connected to the first region at a first bending region; and
a third region connected to the second region at a second bending region,
wherein an edge of the first region connects to the first bending region and the second bending region at a same location.

22. The device storage package of claim 21, wherein the edge of the first region comprises an insertion part.

23. The device storage package of claim 21, wherein the first bending region and the second bending region comprises insertion holes through which the insertion part extends.

24. The device storage package of claim 21, wherein the first region comprises a flat part and a bendable part that folds with respect to the flat part.
